(19) United States
(12) Patent Application Publication
(10) Pub. No.: US 2006/0247844 A1
(43) Pub. Date: Nov. 2, 2006

(54) Intelligent traffic monitoring and guidance system

(76) Inventors: Irving Wang, Tampa, FL (US); Chun Hui Tang, Brooklyn, NY (US)

Correspondence Address: WAYNE V. HARPER, 2112 W. MARJORY AVENUE, TAMPA, FL, 33606-3104, US

(21) Appl. No.: 11/115,540

(22) Filed: Apr. 27, 2005

(51) Int. Cl. G08G 1/00

(52) U.S. Cl. 701/117

(57) ABSTRACT

A method and apparatus for collecting and broadcasting vehicular traffic in a summarized and compressed format suitable for reception by inexpensive wireless devices. In the preferred embodiment, vehicular traffic data is received from one to many inexpensive Doppler Sensors mounted in fixed locations reflecting the speed of vehicles entering one or more known spatial points. In the preferred embodiment of the invention, the averaged vehicle speed is encoded in a compressed, quantized format and formed into a broadcast unit containing data from multiple locations. The broadcast unit is then broadcast over a cellular (e.g. CDMA) network for reception by inexpensive wireless devices. The wireless devices can then use the data to display traffic data in a graphical format or be processed for route planning or other similar functions.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

This invention relates to systems which collect vehicular traffic data on a real-time basis and make it available to commuters. More particularly, this invention relates to systems which continuously collect vehicular traffic data traffic density and speed using sensors at known spatial points and broadcast the data in a compressed format suitable for use by portable wireless devices.

2. Description of the Problem

One of the problems faced by automobile drivers on a daily basis, particularly in densely populated areas, is the possibility that the driver's routes of travel may be unpredictably subject to slow downs and stoppages due to a variety of causes. Such slow downs and stoppages waste commuter's time, increase fuel consumption, exacerbate air pollution and give highly populated areas a bad image. One of the most significant causes of such slow downs, in addition to accidents and other unpredictable events, is inefficient use of existing roadways. Statistics show that in some larger cities in China, major roads which compose only one-third of the road network handle 80% of the all traffic while secondary roads only handle 20% of all vehicular traffic. Improving the efficiency of road utilization efficiency has become a major topic of both government and academic research.

One solution to this problem would be to enable the driver to monitor traffic density and speeds along the driver's projected route of travel real-time or near-time basis using portable, wireless devices the driver can carry while he or she is traveling. When the driver detects a problem along her intended route of travel, he or she can choose another route that is flowing smoothly. If such portable devices to are to accurately display traffic density and speed on a real-time or near-time basis, however, they must continuously receive data on vehicular traffic reflecting traffic density and speed for multiple physical locations. This presents two significant challenges.

First, collecting detailed traffic data for a large municipality requires continuously measuring traffic speed and density at a large number of physical locations. Such a system requires a significant capital expenditure for setting up sensor locations for data collection.

Second, such data has the potential to be extremely voluminous. Many hundreds of vehicles may pass a specific spatial point over the course of a minute. Furthermore, to accurately reflect the flow of traffic along multiple routes, data from many spatial points must be processed. Thus, if vehicular traffic data were broadcast in at its lowest level of detail, it could overwhelm the receiving and processing capacity of small wireless devices.

### DESCRIPTION OF RELATED ART

A number of systems for monitoring the flow of vehicular traffic data have been developed.
a.) Advanced Driver and Vehicle Advisory Navigation Concept (ADVANCE) http://ais.its-program.anl.gov/ADVANCE was a public/private partnership developed by the Federal Highway Administration (FHWA), the Illinois Department of Transportation (IDOT), the University of Illinois at Chicago and Northwestern University operating together under the auspices of the Illinois Universities Transportation Research Consortium (IUTRC), and Motorola, Inc. which was in active development and testing from 1991 to 1996. The basic design principle of the ADVANCE system was to install a dynamic route guidance system called the Mobile Navigation Assistant in individual automobiles which provided the driver with an interface to ADVANCE functions, and collected route travel times and other statistics for transmission (either in real time via RF or delayed via memory cards) to a central database.

A principal disadvantage to the ADVANCE system as it was originally proposed was the need for a massive deployment of Mobile Navigation Assistant, a relatively complex device incorporating GPS positioning, wireless communications, CD-ROM map storage, and data fusion, in 3,000 to 5,000 vehicles, requiring a significant capital expenditure.
b.) The Gary-Chicago-Milwaukee Corridor Project (GCM Corridor). http://www. gcmtravel.com

In 1997, the GCM Corridor project was initiated as a follow up project to ADVANCE, was successfully implemented, and is currently operational. The GCM Corridor project eliminated the use of expensive monitoring and guidance systems in individual vehicles. Central servers in the Illinois DOT Traffic Systems Center (TSC) receive data from loop detectors embedded in the pavement on the expressways. The loop detectors act like metal detectors and can sense when a vehicle is near them. This allows the TSC to count the number of vehicles that have passed over each detector (volume) as well as how long each detector was occupied (occupancy). Simple formulas have been developed to convert this data into travel times and congestion estimates. Traffic data is dynamically displayed on maps which are accessible on the project's web site.

A principal disadvantage to the GCM Corridor project is that traffic data can only be accessed on the projects web site using a web browser. The data is not in a format that is easily displayed on a small device, nor is the data accessible for more complex processing on portable wireless devices such as route planning.
c.) RESCU Traffic Management System, Toronto, Canada (RESCU). http://www.city.toronto.on.ca/rescu

RESCU is a system which is similar in many respects to the GCM Corridor project. The primary source of traffic data are 121 loop detector stations, supplemented by 53 closed circuit television cameras. The system makes traffic data available through automated fax Services (Autofax) conveying up-to-date traffic information to subscribers, a web site showing traffic flow and incident information for the Gardiner Expressway, the Don Valley Parkway, and Lake Shore Boulevard, and a 24-hour voice information system for road construction information.

A principal disadvantage to the RESCU System is that traffic data can only be accessed on the system's web site using a web browser, or in text format on a fax machine, or in more limited for, from a voice information system. The data is not in a format that is easily displayed on a small device, nor is the data accessible for more complex processing on portable wireless devices such as route planning.
d.) Vehicle Information and Communication System (VICS), Japan http://www.vics.or.jp

VICS was developed by Toyota and Japanese government. In VICS, traffic data is reported by road administrators and prefecture police headquarters to the Japan Road Traffic Information Center. The data is then passed to the VICS Center where the data is edited and broadcast to motorists via radio wave beacons on expressways, infrared beacons on main trunk roads, and FM multicast facilities in more remote locations. The data is received by in car navigation units which provide a rich graphical user interface.

One disadvantage of VICS is that data is collected and input manually, requiring considerable effort and limiting the detail which is available. A second disadvantage of the VICS system is that an expensive network of radio wave beacons, infrared beacons, and FM multicast facilities. A third disadvantage of the VICS system is that broadcast data is only usable by expensive car navigation systems.

Therefore, an object of the present invention is to enable the collection of traffic data over a wide area using inexpensive sensor locations and the existing cellular telephone network.

Another object of the present invention is enable the broadcast of traffic data in a compressed format suitable for use by small, portable wireless devices.

Other objects will become apparent to those skilled in the art when the drawings are studied in conjunction with the detailed specification.

### BRIEF SUMMARY OF THE INVENTION

The present invention is a method and apparatus for collecting and broadcasting vehicular traffic in a summarized and compressed format suitable for reception by inexpensive wireless devices.

Vehicular traffic data is received from one to many data sources, inexpensive Doppler Sensors mounted in fixed locations in the preferred embodiment, reflecting the speed of vehicles entering one or more known spatial points.

The data is summarized and compressed by following a series of steps. First, an average vehicle speed is calculated for every data source over a first time interval. Second, the average speed for every data source is encoded in a compressed format. Third, a data unit is formed for every data source, containing a source ID and the encoded, compressed average vehicle speed. Fourth, all such data units which have been created over a second time interval are concatenated into a broadcast unit.

In the preferred embodiment of the invention, the averaged vehicle speed is encoded in a compressed, quantised format by following a series of steps. First, the speed is assigned to one of a group of m ranges numbered consecutively from 0 to (m−1) where m=2ⁿ and n is an integer greater than 1. Each range has a lower bound Rₗ, and an upper bound Rᵤ, where Rₗ, is less than or equal to Rᵤ, The averaged vehicle speed is assigned to an individual range when such speed is less than or equal to Rᵤ and greater than or equal to Rₗ. Second, the number of the range which is selected is encoded as a binary integer which is n bits in width;

In the preferred embodiment of the invention, the broadcast unit is then broadcast over a cellular (e.g. CDMA) network for reception by inexpensive wireless devices. The wireless devices can then use the data to display traffic data in a graphical format or be processed for route planning or other similar functions.

### BRIEF DESCRIPTION OF THE SEVERAL VIEWS OF THE DRAWINGS

FIG. 1. is a diagram showing the high-level, logical structure of the Intelligent Traffic Monitoring and Guidance System (ITMGS)

FIG. 2 is a diagram showing the physical relationship of a Mote to vehicular traffic.

FIG. 3 is a table of numerical ranges used to quantize average vehicular speeds.

FIG. 4 is a diagram of the physical layout of the Traffic Data Upload System which shows the relationship between Motes, Data Collection Points, and Base Stations.

FIG. 5 is a diagram of the data format used by Motes to transmit traffic data to other Motes and to Data Collection Points and used by Data Collection Points to transmit traffic data to Base Stations.

FIG. 6 is a diagram of the physical layout of the Central Data Processing System which shows the relationship between Base Stations, and Servers.

FIG. 7 is a diagram of the data format used by the Server of the Central Data Processing System to transmit traffic data to Base Stations and which is broadcast to End User Terminals within the End User Subsystem. This is also the format used to transmit data from Data Collection Points to the Base Station.

FIG. 8 is a diagram of the physical layout of the Traffic Data Distribution Subsystem which shows the relationship between Base Stations and End User Terminals.

### DETAILED DESCRIPTION OF THE PREFERRED EMBODIMENT

Within the context of this description, the term “CPU” should be understood to include programmable devices comprising a single integrated circuit, such as a microprocessor, or may comprise any suitable number of integrated circuit devices and or circuit boards working in cooperation to accomplish the functions of a CPU. The term “memory” should be understood to include any type of memory known to those skilled in the art including, but not limited to, Dynamic Random Access Memory (DRAM), Static RAM (SRAM), flash memory, cache memory, Read-Only Memory (ROM). The term “auxiliary storage” should be understood to include any other type of DASD known to those skilled in the art, including CD-ROM drives, hard disk drives, optical drives, etc.

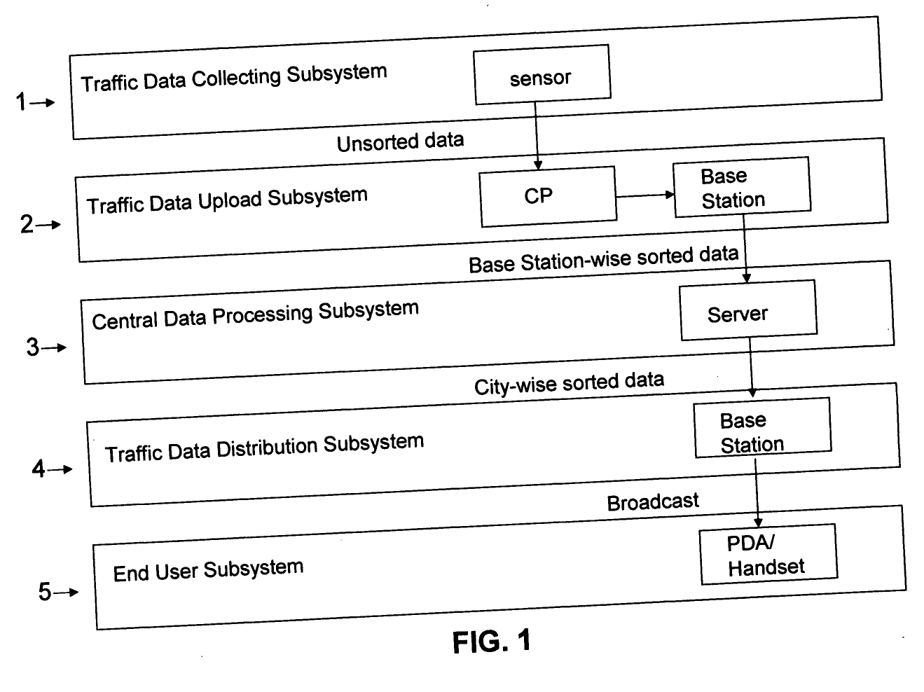

Referring first to FIG. 1, the Intelligent Traffic Monitoring and Guidance System (ITMGS), is composed of 5 logical subsystems, a Data Collecting Subsystem, 1, a Data Upload Subsystem, 2, a Central Data Processing Subsystem, 3, a Traffic Data Distribution Subsystem, 4, and a End User Subsystem, 5.

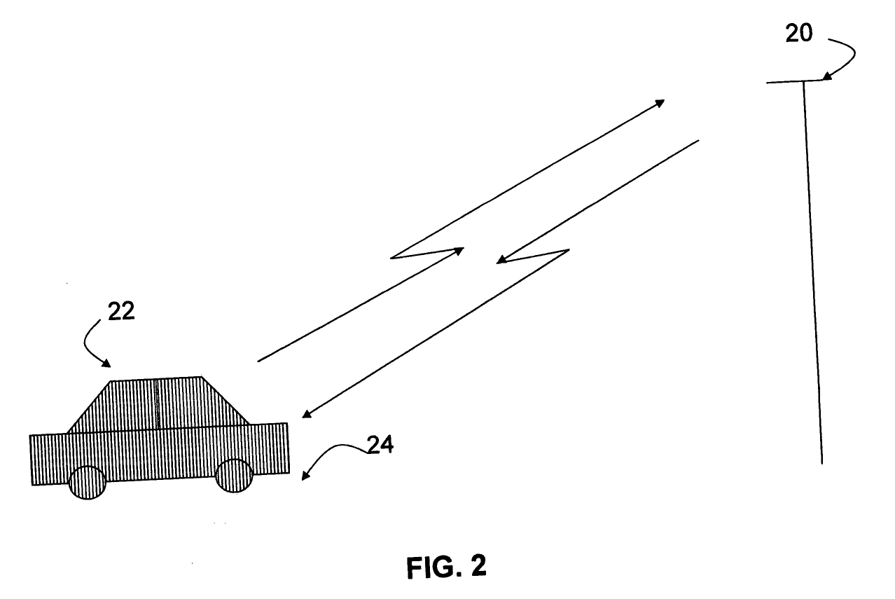

Referring next to FIG. 2, the Data Collection Subsystem is implemented by a network of Motes 20, sensor-packed, self-contained, wireless beacons mounted on fixed locations, for example, on telephone poles or buildings. In ITMGS, such motes contain Doppler sensors, such as which sense the speed of vehicles 22 passing a fixed point 24, typically a point centered on a traffic lane along a major road. The exact layout of the sensor network in any given area will on parameters such as terrain and highway structure and will need to be customized on a case by case basis.

In the preferred embodiment, a Doppler sensor is comprised of a microwave transmitter which transmits microwaves towards oncoming traffic and a magnetometer which receives microwaves reflected off of oncoming traffic. Within every Mote 20, Doppler sensors are operatively connected to a CPU which is operatively connected to a data buffer implemented in memory or auxiliary storage. The CPU is also operatively connected to a radio transceiver capable of transmitting data at conventional radio frequencies, for example, 433, 868/916, or 310 MHz. Sensors continuously transmit measurements to the CPU within the mote. Every K seconds, for example, 30 seconds, the CPU stores the vehicle speed received from a Doppler sensor in the data buffer attached to the CPU. Every L seconds, for example, every 300 seconds, the CPU calculates an average speed, in the case of the preferred embodiment, a simple numerical average, for all data stored within the data buffer within the last L seconds.

The Mote, as described above, could be constructed of commercially available, off the shelf components, such as a device comprised of an Crossbow MPR400 Wireless Measurement System operatively connected to a MTS310 Multi Sensor Board. See Hsieh, “Using sensor networks for highway and traffic applications”, (Potentials, IEEE, pp. 13-16, vol 23, issue 2, April-May, 2004). The CPU, memory, transceiver, and microwave reside within the MPR400 and magnetometer resides within the MTS310. Microwaves transmitted by the MPR400 are reflected of off vehicular traffic and are received by the magnetometer within the MTS310. The speed of vehicular traffic is computed by the CPU within the MPR400 using the difference between frequencies of the transmitted microwaves and the received microwaves using the Doppler formula The data sheets for the MPR400 and the MTS310 products may be viewed at Crossbow's web site, www.xbow.com.

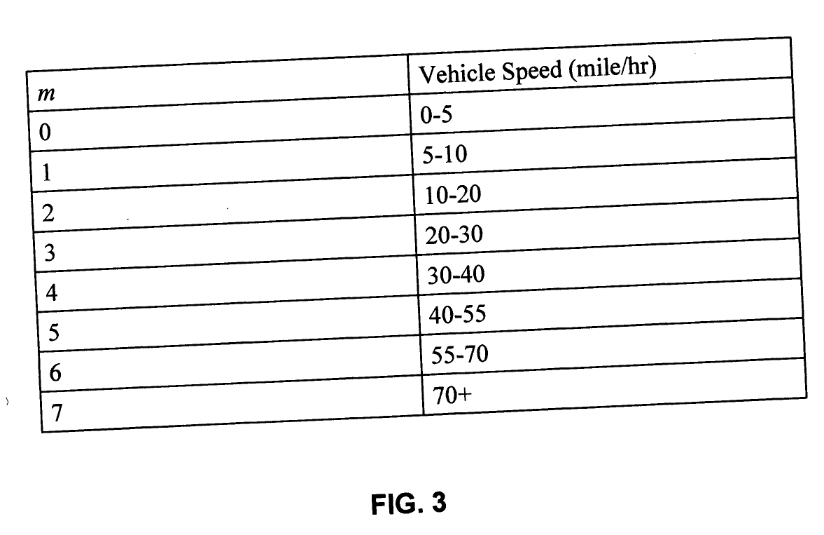

Referring next to FIG. 3, the averaged speed calculated by the microprocessor within a Mote is encoded in a compressed, quantized format by mapping the speed to one of a number of m ranges. In one embodiment, there are 8 ranges, the ranges are contiguous with no gaps, are non-overlapping, and encompass all possible average speeds. The number of the range selected is further encoded and compressed as a binary integer which is n bits in width, where m=2. In the case of the preferred embodiment, the integer is 3 bits in width. Thus, for example, an average speed of 42 mph maps to range number 5, which is then encoded as a binary integer 3 bits in width.

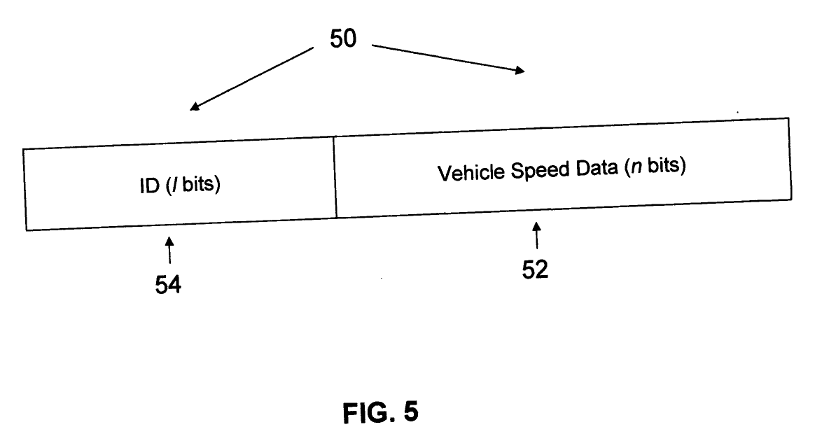

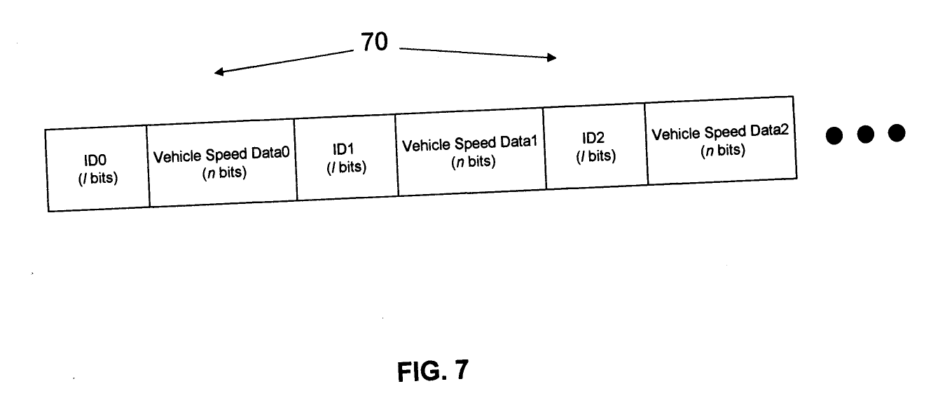

Referring next to FIG. 5, the quantized, compressed, average vehicle speed is then used to create a data unit which contains a source ID of l bits, 54, and a quantized vehicle speed of n bits, 52. The data unit is then transmitted by the radio transceiver within the Mote directly to a Data Collection Point within the Data Upload Subsystem or to another Mote which retransmits the data unit to a Data Collection Point within the Data Upload Subsystem. Every Mote is uniquely associated with a single Data Collection Point. The source ID, 54, used by the Mote to create data units as shown in FIG. 5 is pre-assigned to a Mote or a group of Motes at the time the Mote is configured and installed. Depending on the design for a particular city, The size of the ID, l, will vary depending on the design for the specific municipal area, for example, 8 bits. The length of the source ID could be 0 if there is no need to differentiate between specific Motes. Where a Mote is retransmitting data received from other Motes, the Mote may concatenate the data units it has received with data units created by that mote to create a single unit of transmission, similar to the unit of transmission shown in FIG. 7, which contains one to many data units.

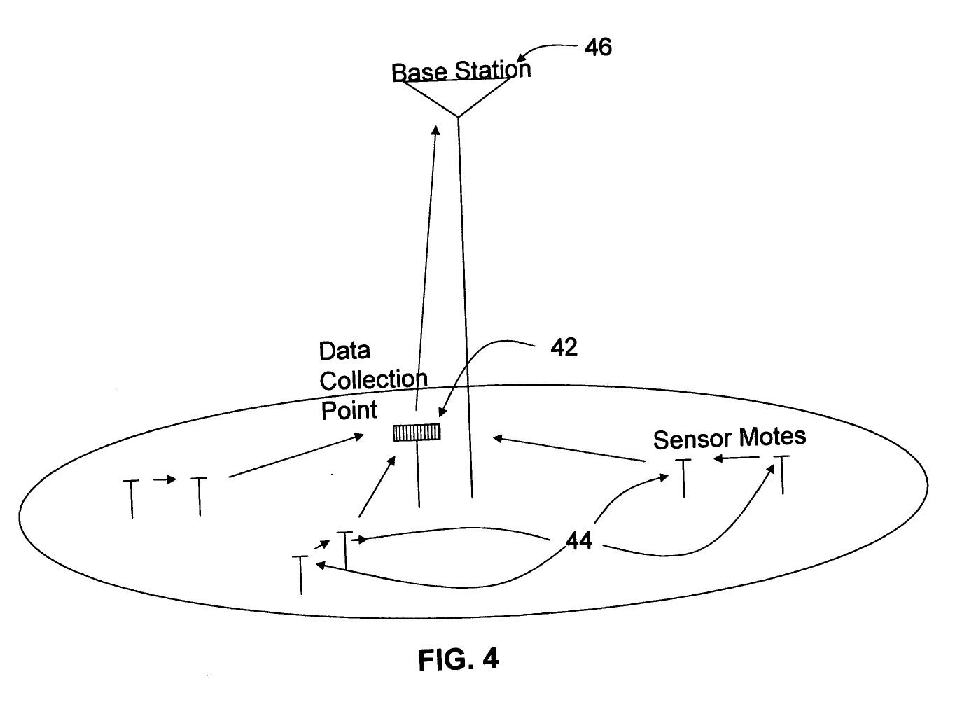

Referring next to FIG. 4, the Traffic Data Upload System contains one or more Data Collection Points 42 and one or more Base Stations 46. A Data Collection Point 42 collects traffic data from a specific group of Motes 44, consolidates and transmits the data to a Base Station 46. The Data Collection Point 42 contains a CPU operatively connected to a data buffer implemented in memory or auxiliary storage. Within Data Collection Point, the CPU is also operatively connected to a radio transceiver, and a cellular transmitter that operates in the same band as the local cellular system. The radio receiver within Data Collection Point 42 is operated at the same transmission frequency as the transceivers of the group of Motes 44 from which that Data Collection Point 42 collects data. The receiver is used to receive traffic data such as that shown in FIG. 5, transmitted by the Motes.

The cellular transmitter within the Data Collection Point 42 is used by the Data Collection Point 42 to communicate with a Base Station 46 for the purpose of transmitting consolidated traffic data to that Base Station 46. The transmitter contains a mobile phone chip set that can manage the access to the Base Station 46. The Data Collection Point 42 accesses the Base Station as a regular handset over a preexisting backbone cellular network. The Data Collecting Points 42 are located well inside sectors in the cellular system to avoid handoff problems. The Data Collection Point 42, as described above, could be constructed of commercially available, off the shelf components, such as a device comprised of a Crossbow MPR400 Wireless Measurement System operatively connected to a conventional cellular telephone. The CPU, memory, and transceiver reside within the MPR400 and the cellular transmitter resides within the cellular telephone. The data sheet for the MPR400 may be viewed at Crossbow's web site, www.xbow.com. Base Stations, 46, as described above, are part of the existing cellular telephone network.

As a Data Collection Point 42 receives data from one or more Motes 44, it accumulates the data, formatted as shown in FIG. 5 and FIG. 7, in its data buffer. Every S seconds, for example, 300 seconds, the CPU merges the data stored in data buffer into a single transmission unit within the data buffer by concatenating the data units it has received to create a single unit of transmission, similar to the unit of transmission shown in FIG. 7, containing one to many data units. The unit of transmission is then transmitted by the cellular transmitter of the Data Collection Point 42 to a Base Station, 46, of FIG. 4 using a cellular transmission protocol supported by the existing cellular telephone network. For example, in a CDMA mobile network the data is transmitted using Access Channel or Enhanced Access Channel. Data Burst Message format is one of the possible message formats which can be used for this purpose. Nothing in this specification should be taken, however, to limit this invention to CDMA networks. The Base Station, 46 of FIG. 4, in turn, transmits the data without further alteration to a Server within the Central Data Processing System using a T1 or E1 connection within existing cellular telephone network.

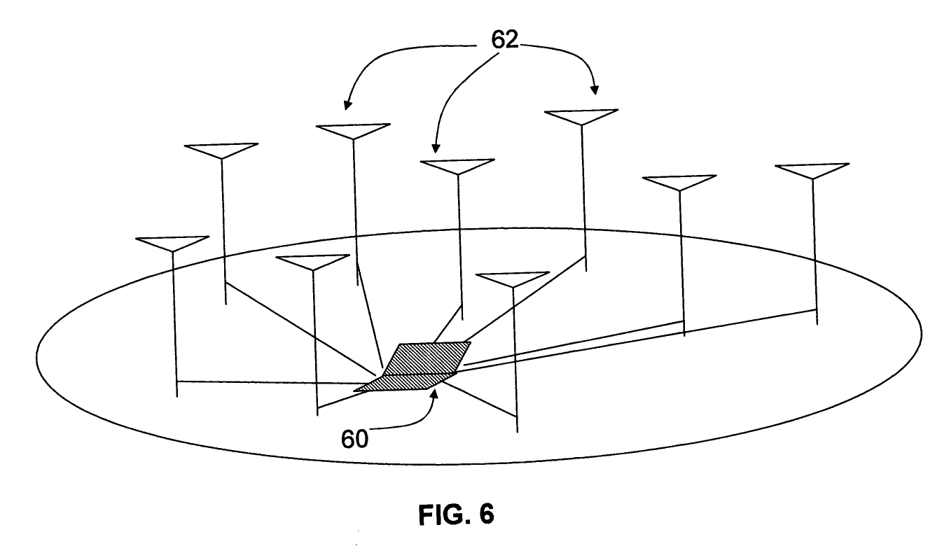

Referring next to FIG. 6, the Central Data Processing System is composed of Servers 60 which are located within groups of Base Stations 62. The server could be located in or near a Mobile Switching Center. The area a server services will depend on the needs of the local ITMGS, that is to say, on the number and density of the traffic routes being monitored. For example, it could cover the Tampa, Fla. metropolitan area or the entire central Florida region, including Tampa Bay and Orlando metropolitan areas. The Server 60 is comprised of a CPU which is operatively connected to a data buffer implemented in memory or auxiliary storage. The CPU is also operatively attached to one or more T1 or E1 type connections which are in turn connected to the Base Stations 62 within the Server's area of coverage. The Server could be constructed using one or more conventional PC servers with T1 or E1 connection cards.

Vehicular traffic data formatted as shown in FIG. 7 is received by the Server 60 from Base Stations 62 through the T1 or E1 connections between the Server 60 and the Base Stations 62. The data is accumulated in the Server's data buffer. Every T seconds, for example, 300 seconds, the Server sorts the data in a specific sequence required by the End User Subsystem, for example by Source ID. The Server may also modify the traffic data according to a pre-defined algorithm (e.g. if the measured speed is faster than the local speed limit, the measured speed could be set to the local speed limit). The merges all data into a single Broadcast Unit, as illustrated in FIG. 7, which contains data units from multiple Data Collection Points and multiple Motes. The Unit of Broadcast 70 is then transmitted to the all Base Stations 62 in the Traffic Data Distribution Subsystem within the Server's area of coverage over the T1 or E1 connections between the Server 60 and the Base Stations 62.

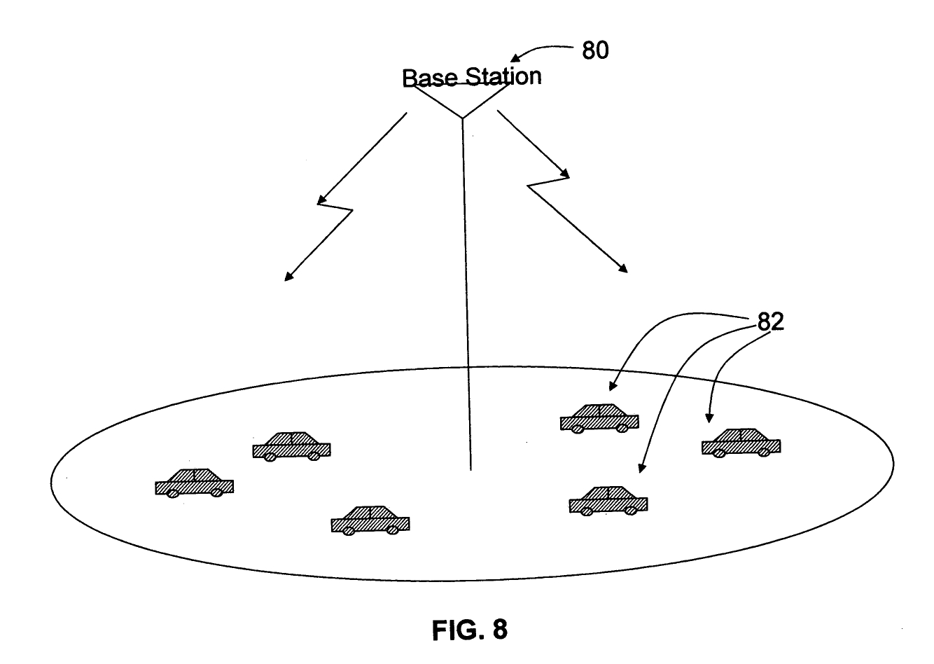

Referring next to FIG. 8, the Traffic Data Distribution Subsystem is implemented using Base Stations, 80, which receive data traffic data composed of broadcast units, 70 of FIG. 7, transmitted from the Server 60 of FIG. 6 of the Central Data Processing System. The Base Stations 80 in turn broadcast the data received from the Central Data Processing System without further alteration to End User Terminals 82 in the End User Subsystem. In a CDMA system, the Data Burst Message format is used to broadcast or multicast the data. The Data Burst Message can be multicast in the paging channel, the broadcast common control channel, or the traffic channel. Nothing in this specification should be taken, however, to limit this invention to CDMA networks. If the cellular system does not support broadcast/multicast, the regular traffic channel can be configured to carry the data in a manner identical to regular cellular phone service.

The End User Subsystem is implemented on End User Terminals 82 which are portable wireless devices such as PDA's and cellular telephones, which are capable of receiving the data and displaying representations of traffic patterns and density. For example, after the End User Subsystem receives the broadcast/multicast data, the System could coordinate the data with the city map information that has been previously stored in its memory display traffic data on map (e.g. different colors represent different traffic conditions). The System could also provide route planning capabilities. For example, the end user could input his or her current location on the and desired destination on the wireless device and the Subsystem could then determine the best route from the current location to the destination and then display the result in graphic or text format. If the portable wireless device included a GPS, the subsystem could obtain the device's current position from the GPS.

The foregoing description of the preferred embodiment of the invention has been presented for purposes of illustration and description, and is not intended to be exhaustive or to limit the invention to the precise form disclosed The description was selected to best explain the principles of the invention and the practical application of those principles to enable others skilled in the art to best utilize the invention in various embodiments and various modifications as are suited to the particular use contemplated.

We claim:

1. A method of broadcasting vehicular traffic data comprising the steps of:
receiving data from one to many data sources in which the data received from an individual data source contains one to many first data units, each first data unit containing the speed of an individual vehicle, Vᵣ entering a spatial point associated with the individual data source from which the first data unit has been received;
calculating an averaged vehicle speed for every data source from the first data units received from that source over a first time interval;
creating a second data unit from each averaged speed, the second data unit containing a first field containing an ID identifying the source of the first data unit and a second field containing the averaged vehicle speed, Vr, encoded in a compressed format, V_{c};
concatenating one to many second data units created from data obtained from one to many data sources over a second time interval into a single broadcast unit;
broadcasting the broadcast unit.

2. The invention in claim 1 in which the speed in the first data unit, Vᵣ, is encoded in a compressed format, V_{c}, using a method comprising the steps:
assigning the speed, Vᵣ, to one of a group of m ranges numbered consecutively from 0 to (m−1) where m=2ⁿ and n is an integer greater than 0, each range having a lower bound Rₗ, and an upper bound Rᵤ, where Rₗ is less than or equal to Rᵤ, Vᵣ being assigned to an individual range when Vᵣ is less than or equal to Rᵤ and greater than or equal to Rₗ;
forming V_{c} by encoding the number of the range to which Vᵣ has been assigned as a binary integer which is n bits in width;

3. An apparatus for broadcasting vehicular traffic data comprising the steps of:
a means for receiving data from one to many data sources in which the data received from an individual data source contains one to many first data units, each first data unit containing the speed of an individual vehicle, Vᵣ, entering a spatial point associated with the individual data source from which the first data unit has been received;
a means for calculating an averaged vehicle speed for every data source from the first data units received from that source over a first time interval which is operatively connected to the means for receiving data;
a means for creating a second data unit from each averaged speed, the second data unit containing a first field containing an ID identifying the source of the first data unit and a second field containing the averaged vehicle speed, Vᵣ, encoded in a compressed format, V_{c}, which is operatively connected to the means for calculating an averaged vehicle speed;
a means for concatenating one to many second data units created from data obtained from one to many data sources over a second time interval into a single broadcast unit;
a means for broadcasting the broadcast unit.

4. The invention in claim 3 in which the speed in the first data unit, Vᵣ, is encoded in a compressed format, V_{c}, using a method comprising the steps:
assigning the speed, Vᵣ, to one of a group of m ranges numbered consecutively from 0 to (m−1) where m=2ⁿ and n is an integer greater than 1, each range having a lower bound Rₗ, and an upper bound Rᵤ, where Rₗ is less than or equal to Rᵤ, Vᵣ being assigned to an individual range when Vᵣ is less than or equal to Rᵤ and greater than or equal to Rₗ;
forming V_{c} by encoding the number of the range to which Vᵣ has been assigned as a binary integer which is n bits in width;
